(19) United States
(12) Patent Application Publication
(10) Pub. No.: US 2004/0265778 A1
(43) Pub. Date: Dec. 30, 2004

(54) Method and apparatus for use with dental implants

(76) Inventors: Howard Kliff, Highland Park, NJ (US); Jordan Mittler, Woodbury, NY (US); Peter Scheck, Freeport, NY (US); Adam Wiggitt, Randolf Center, VT (US)

Correspondence Address: FROMMER LAWRENCE & HAUG, 745 FIFTH AVENUE- 10TH FL., NEW YORK, NY, 10151, US

(21) Appl. No.: 10/606,640

(22) Filed: Jun. 26, 2003

(51) Int. Cl. A61C 17/00; A61C 3/00

(52) U.S. Cl. 433/143; 433/141

(57) ABSTRACT

A method of forming a hand tool by providing a mold having at least two sections injecting a material for forming the hand tool into the mold, and forming a sharpened edge surface on the hand tool along a surface formed by the parting line of the mold. The hand tool may be a dental tool having a working surface for contacting a patient's teeth. The working surface is formed of a substantially a flat curved section extending from a distal end of the dental tool. The distal end of the curved section having a facet extending substantially parallel to a longitudinal axis of the dental tool and having a sharpened surface formed on a proximal edge surface of the facet.

### BACKGROUND OF THE INVENTION

1. Field of the Invention

The present invention relates to a new and useful apparatus and method for use with dental implants. Specifically, the present invention is directed to a non-metal dental cleaning tool for use with titanium implants, a method of forming the non-metal dental cleaning tool, and a method and apparatus for insuring proper use of the tool.

2. Description of the Related Art

At some point in his or her life nearly everyone has the need of a dentist. Frequently, dental care is part of a yearly or twice yearly regimen of preventing decay and promoting oral hygiene. During these regular visits to the dentist, the dentist or more likely a dental technician will perform a cleaning procedure on the patient's teeth. This cleaning procedure will generally include polishing the teeth and removing deposits such as plaque, tarter, and calculus from both above and below the gum line of a patient. To remove these deposits it has been the custom in the industry to utilize metal tools such as picks and scrapers in a manual removal process. Other procedures have also been developed more recently using a powered mechanism such as an ultrasonic scrapers.

In another area of dental care, surgical implants have been developed for patients who have for one reason or another lost one or more of their teeth. These surgical implants are comprised of a portion that strongly resembles a regular tooth and an anchoring mechanism that is surgically implanted in the patient. After implant, the bone tissue grows around the implant to insure rigid installation of the new tooth this process is called osseo-integration. The anchoring mechanism and more particularly a portion of the anchoring mechanism that represents the transitional part of the implant is often made of titanium. Titanium has the great advantage that it is very light, resists adherence of bacteria and the like, and further is very strong. Accordingly, titanium is nearly ideal for use in dental applications. Titanium does have one significant drawback and that is that despite its strength titanium is a soft metal that is prone to scratching by other metals. Specifically, the traditional stainless steel scraping tools that a dentist uses will severely scar the titanium implant. These scratches are not important for cosmetic reasons but rather for the continued health of the patient. Because the transitional pieces of the implant are below the gum line this is where the scratching of the implant occurs. As a result, these scratches in the implant provide prime locations for bacteria and other gum disease causing agents to locate. Once located these gum disease causing agents can rapidly multiply and may result in pain, bleeding for the patient as well as severe gum disease.

Traditionally, dental tools have been made of metal and more particularly a stainless steel. These materials lend themselves to the forming of a sharpened edge. After forging of the tool the surfaces to be sharpened may have an edge put on them by honing or grinding. Such methods, however, are not applicable to many non-metal materials such as plastics. Indeed, the heat created by grinding or honing can actually melt the plastic and will not sharpen an edge. There are some plastic dental tools such as the implant scalers offered by Premier Dental Products Company that may attempted to be sharpened, however, the edge derived from the sharpening of these plastic dental tools does not meet the demands of the dental industry. This is partially due to the flexible nature of the materials used in making these non-metal tools, but is primarily due to the inability of these tools to form a sharp edge with which to scrape the teeth.

Furthermore, steel dental tools are very expensive to manufacture, and therefore lend themselves to being used multiple times. Such use requires sterilization between uses, another expensive procedure. Additionally, there is often no way for a user to be sure that a product has been properly sterilized. Therefore, a product that removes this sterilization process would be beneficial.

Accordingly, there is a need for a dentist tool that does not scratch titanium implants but also provides a sufficiently sharp edge that routine cleaning of the patient's teeth can be performed, and that insures patient cleanliness.

### SUMMARY OF THE INVENTION

A method of forming a hand tool comprising the steps of providing a mold having at least two sections, injecting a material for forming the hand tool into the mold, wherein a sharpened edge surface on the hand tool is defined by a surface formed by the parting line of the at least two sections of the mold.

There is also disclosed a dental tool comprising a handle for grasping the tool, and a working surface for contacting a patient's teeth. The working surface is formed of a substantially a flat curved section extending from a distal end of the dental tool. The distal end of the curved section has a facet extending substantially parallel to a longitudinal axis of the dental tool and a sharpened surface formed on a proximal edge surface of the facet. The facet length may extend substantially parallel to or be angled away from the longitudinal axis of the dental tool. The facet may also have a greater length on a first side of the facet and smaller length on a second side of the facet.

Additionally, there is disclosed an apparatus for detecting the performance of a sterilization procedure. The apparatus has a location for application of a material and a material deposited in the location. The material changes its visual characteristics upon the performance of a sterilization procedure.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a perspective view of a dental instrument according to one of the embodiments of this invention.

FIG. 2 is a perspective view of a dental instrument according to another embodiment of the present invention.

FIG. 3 is a close-up perspective view of a working blade of a dental instrument as shown in FIG. 1.

FIG. 4 is a close-up perspective view of a working blade of a dental instrument as shown in FIG. 3.

FIG. 5 is a flow chart depicting the steps for molding a product according to one embodiment of the present invention.

### DETAILED DESCRIPTION

One embodiment of the present invention is directed to a non-metal dental tool.

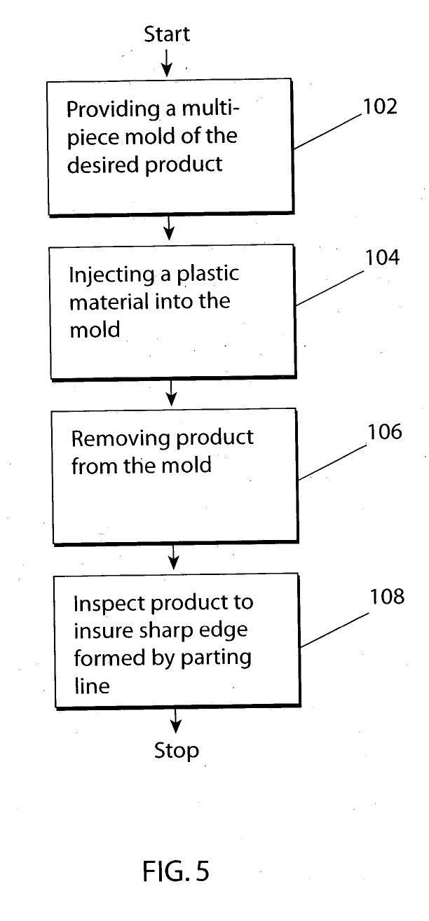

Naturally, when one is looking for non-metal materials to form a product from plastics are likely candidate. Plastic components are often formed by injection molding a process described in the steps outlined in the flow chart of FIG. 5. This process requires the use of a multi-part mold that bears a three-dimensional image of the product, 102. Molten plastic may then be injected into the mold when it is in a closed state, 104. After cooling, the mold can be opened and the molded product has been formed removed from the mold 106. The edge created by the parting line is then inspected 108 to insure that it is not been deformed and the dental tool is processed for sterilization and packaging.

In forming any item through injection molding there is formed a parting line. The parting line represents the place where the two or more pieces of the mold come together. Despite the very close tolerances of the mating surfaces of the mold there is always a portion of the molded materials that seeps into a gap between the two mating surfaces. In the molded product this material, which is still attached to the product is called the parting line. Typically, the parting line is a frustrating part of the injection molding process, and requires removal such as by sanding. Often this removal is a time consuming and costly process. Additionally, this parting line is often very sharp creating a hazard for those who come in contact with it. However, as will be discussed below, in accordance with the invention this parting line can be used advantageously, if properly positioned to provide a desired sharp edge on the molded product.

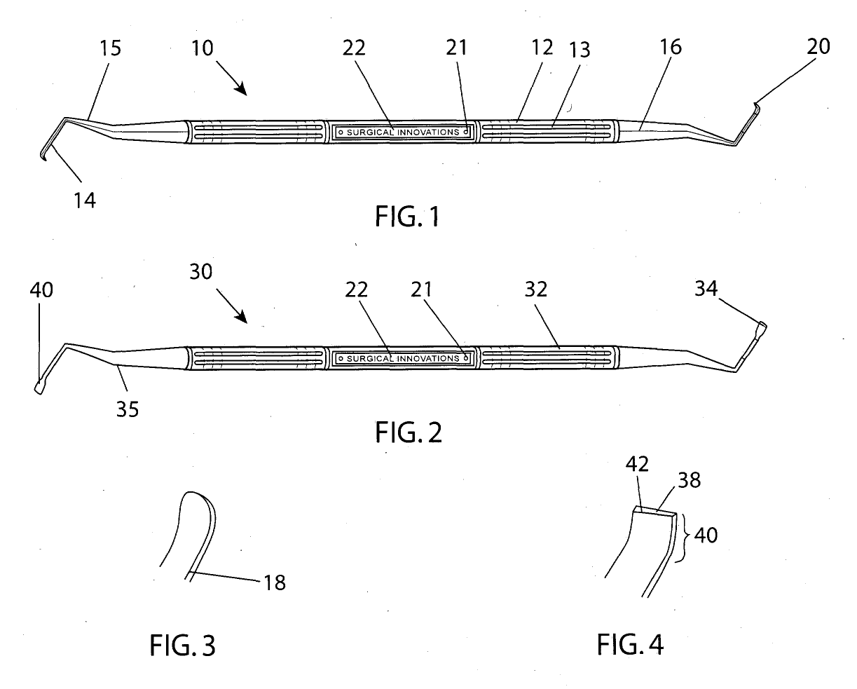

A dental tool 10 according to one embodiment of the present invention is shown in FIG. 1. The dental tool includes a handle 12, two working shanks 15, two working blades 14, a parting line 16, two sharp edges 18, and a recessed nameplate holder 20. Dental tools of this sort are used to scrape matter from teeth. One aspect of the present invention, a shown in FIG. 1 is the use of the parting line 16 as the sharp edge 18 for scraping of the teeth. As shown in FIGS. 1 and 3, the required sharp edge of the dental tool is defined by the parting line between the mold portions. This parting line forms the sharp edge as it approaches the end 20 of the working blade 14. It has been determined that the sharp edge 18 formed by the parting line is of sufficient sharpness to remove deposited materials from teeth and in particular from dental implants without scratching the relatively soft surfaces of the dental implants. Accordingly, with reference to FIG. 5, the parting line is not sanded but rather is retained and creates the sharp edge for scraping the implants. Such a process for forming a dental tool has several advantages including, no need to sharpen the tool after it has been molded, or to remove the parting line from the distal and delicate ends of the tool as these form the sharp edges that will be used for tooth and implant cleaning. Of course, this procedure for utilizing such a parting line may be applied to any molded object in which a sharpened edge is desired.

In utilizing the parting line to form the sharp edge of the dental tool, the time and effort necessary to form the sharp edge by grinding and to eliminate the parting line of a molded plastic product are greatly reduced while still providing a tool with a very sharp edge.

Another aspect of the present invention is that, by forming dental tools from plastic, they can be made for single use only applications. Utilization as single use heightens the sanitation possibilities regarding the use of scrapers. Traditionally, with tools made of metal and even with some of the plastic tools mentioned above, there is need for them to be sterilized. This can be a time consuming and costly process. Following every use of a metal dental instrument, the instrument must be sent out to a facility and be sterilized. Following sterilization the instrument is packaged and returned to the dentist. Accordingly, in addition to the initial cost of the instrument, the dentist must continually pay for the sterilization service. Alternatively, a dentist may maintain an in-house sterilization apparatus, but this apparatus is both time consuming and expensive to operate.

Still another aspect of the present invention is that the dental tools can be made to an ergonomically comfortable size for the user. Many dental professionals find that the relatively small diameter of the standard size dental tools to be difficult to use and uncomfortable for the user over time. Accordingly, through the use of plastics and the molding technique described above the present invention may be formed with a diameter than the standard size. This increase in size also increases the comfort of the dental professional and safety for the patient.

A further aspect of the present invention is the use of channels formed into the handle 12 of the dental tool 10 as shown in FIG. 1. The channels perform at least two functions. Initially, the forming of these channels there is less material used in the forming of the tools resulting in a cost savings in manufacturing and a reduced weight of the tool. By reducing the weight of the tool, the user does not fatigue as quickly, and is able to better use the tool.

The other function of the channels is to provide an anti-slippage feature for the dental tool 10. During an examination a patient may begin to bleed. Alternatively, some individuals are prone to producing a great deal of saliva during the examination. Both of these fluids can make it very difficult for a dental professional to safely grip the dental tool. This results in a safety concern for both the patient and the dental professional, particularly as many dental tools have very sharp edges or are formed to a sharp point. By providing channels 13 in the handle 12, the fluid such as blood or saliva is allowed to drain away from the gripping surface or periphery of the handle 12 of dental tool 10 and the gripping ability of the user is thereby increased. This feature is particularly important when the dental professional is using latex or other protective gloves. The gloves and the tool can both become very slippery when in the presence of fluids such as saliva and blood. Accordingly, the application of channels 13 to the handle 12 of the dental tool 10 increases the safety for both the dental professional and the patient.

Dental tools formed of plastic that are to be used many times also require sterilization whether it is through heat, autoclaving, cold sterilization, chemical vapor, or UV sterilization. However, a benefit is presented when these instruments are formed of a material enabling single use and disposal. No time or expense is lost for the dentist, or more likely his staff, in gathering the instruments to be sent out for sterilization. The patient is provided with a safe tool that will only ever be used on them. And because it is a single use tool, both the patient and the dentist are assured that the tool will be sharp and perform the task for which it was designed.

A further embodiment of the present invention is a sterilization indicator. As discussed above, one benefit of plastic dental tools is the fact that they can be discarded and do not need to be reused. This aside, there may occur instances where because of the price considerations and because of the sharp and useful edge provided by the parting line it appears desirable to sterilize and attempt to re-use the plastic instrument.

To protect the patient from such practices it is necessary to affix to the plastic dental instrument an indicator that changes visual characteristics upon being exposed to sterilization media. One place for affixation of such an indicator is the nameplate holder 20. In FIGS. 1 and 2 name plate holder 20 contains an indicating dot 21. This indicating dot changes characteristics upon being exposed to the sterilization media. For example, the dot could change colors from green to red upon exposure. Alternatively, the word DANGER could appear in the nameplate holder, or a character could appear in the nameplate holder. Other signals that change a particular characteristic in response to a sterilization procedure could be used without departing from the scope of the present invention. Any of these would signal the patient that the dentist or technician was about to use a tool which had been intended for single use but has been sterilized following that initial use. Such indicators enable the patient to avoid exposure to a tool that had been previously used. By preventing exposure to the previously used tool the patient is insured that they are safe from contamination by previous patients and further that the tools being used on them are sharp. Both of these factors are important to the patient in terms of comfort during treatment and piece of mind.

Another embodiment of the present invention is a dental tool having a particular design of a working blade. As shown in FIGS. 2 and 4 the dental tool is formed of a handle 32, two working shanks 35 two working blades 34, two sharp edges 38, and a recessed nameplate holder 20. The working blade 34 is comprised of a substantially flat curved surface 40 that curves away from the working shank 35. At the distal end of the flat curved surface 40 is a facet 42. The facet 42 may be substantially perpendicular to the longitudinal axis of the dental tool 30. Alternatively, the facet may be angled away from the longitudinal axis of the dental tool 30. The proximal edge 38 of the facet 42 is sharp and is the scraping surface. The facet 42 may be square having the same length on both sides of the sharp edge 38, or alternatively it may have a trapezoidal shape with a greater length on one side of the edge 38, and a narrower length on a second side of the edge 38. Still further, the sharp edge 38 may be straight or have a curvature. The curvature may be either concave or convex. The shape of this apparatus allows for an improved cleaning of titanium implants without damaging the implants. Sharp edge 38 may be formed as noted above, as being defined by the parting line of two parts of a mold used to form the dental tool.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

We claim:

1. A method of forming a hand tool comprising the steps of
providing a mold to produce said hand tool having at least two sections; and
injecting a material for forming the hand tool into the mold, wherein a sharpened edge surface on the hand tool is defined by a surface formed by the parting line of the at least two sections of the mold.

2. The method of claim 1, wherein the hand tool is a dental scraper.

3. The method of claim 1, wherein the material is suitable for scraping titanium without damaging the surface.

4. The method of claim 1, wherein the hand tool is a single use disposable dental tool.

5. The method of claim 4, wherein the dental tool further comprises channels formed in a handle portion thereof, whereby the channels dissipate fluids which come in contact with a gripping surface of the handle.

6. A dental tool comprising:
a handle for grasping the tool; and
a working surface for contacting a patient's teeth, wherein the working surface is formed of a substantially a flat curved section extending from a distal end of the dental tool, the distal end of the curved section having a facet and having a sharpened surface formed on a proximal edge surface of the facet, the facet having a length that is a greater on a first side of the facet and smaller on a second side of the facet.

7. The dental tool of claim 6, further comprising a second working surface for contacting a patient's teeth extending from a proximal end of said dental tool.

8. The dental tool of claim 6, wherein the facet length extends substantially parallel to the longitudinal axis of the dental tool.

9. The dental tool of claim 6, wherein the facet is angled away from the longitudinal axis of the dental tool.

10. The dental tool of claim 6, wherein the sharpened surface is curved.

11. The dental tool of claim 6, wherein the sharpened surface is straight.

12. The dental tool of claim 6, wherein the dental tool is formed of a plastic.

13. The dental tool of claim 6, further comprising a sterilization indicator.

14. The dental tool of claim 6, wherein the tool is disposable.

15. The dental tool of claim 6, wherein the handle is formed to have a diameter larger than the standard size.

16. The dental tool of claim 6, wherein said sharpened surface is defined by a surface formed by a parting line between two sections of a mold utilized to form said dental tool.

17. The dental tool of claim 6 further comprising channels formed in the handle, whereby the channels dissipate fluids from a gripping surface of the handle.

18. An apparatus for detecting the performance of a sterilization procedure comprising:
a tool having a location for application of a material; and
a material deposited on the location, said material changing its visual characteristics upon the performance of a sterilization procedure.

19. The apparatus of claim 18, wherein the material changes color upon exposure to a sterilization procedure.

20. The apparatus of claim 18, wherein a figure is displayed in the material upon exposure to a sterilization procedure.

21. The apparatus of claim 18, wherein a word is displayed in the material upon exposure to a sterilization procedure.

22. The apparatus of claim 18, wherein the location is a nameplate portion of the apparatus.

23. The apparatus of claim 18, wherein the tool is a dental tool.
